(19) United States
(12) Patent Application Publication
(10) Pub. No.: US 2011/0231426 A1
(43) Pub. Date: Sep. 22, 2011

(54) SONG TRANSITION METADATA

(75) Inventors: Erick L. Fejta, Seattle, WA (US); Jessica E. Zahn, Renton, WA (US)

(73) Assignee: MICROSOFT CORPORATION, Redmond, WA (US)

(21) Appl. No.: 12/729,151

(22) Filed: Mar. 22, 2010

(51) Int. Cl. G06F 17/30; G06F 15/16

(52) U.S. Cl. 707/769; 709/203; 707/705; 707/E17.014

(57) ABSTRACT

Various embodiments provide a transition service that provisions transition metadata files for use by client devices. The transition metadata files are configured to provide song-specific transitions between songs. In at least some embodiments, the transition service receives a request for a transition metadata file associated with at least an entry song from a client device. The transition service then selects an associated transition metadata file and transmits the associated transition metadata file to the client device for execution. When executed during the playback of the entry song at the client device, the transition metadata file provides a transition from the entry song to an exit song. In at least some embodiments, the transition metadata files are created by a DJ service that provides transitions from specific entry songs to specific exit songs.

### BACKGROUND

Today, users create music playlists that can contain gaps or silence between songs which can detract from the listening experience. For instance, if a user creates a playlist of favorite songs, there may be a short gap or silence between each song as a currently-playing song ends and a next song in the playlist begins. Some users enjoy listening to mixes of music by professional disc jockeys (“DJs”) that create seamless transitions from one song to the next. However, users are required to listen to the specific order of songs selected by the DJ when listening to DJ-mixed music.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Various embodiments provide a transition service that provisions transition metadata files for use by client devices. The transition metadata files are configured to provide song-specific transitions between songs. In at least some embodiments, the transition service receives a request for a transition metadata file associated with at least an entry song from a client device. The transition service then selects an associated transition metadata file and transmits the associated transition metadata file to the client device for execution. When executed during the playback of the entry song at the client device, the transition metadata file provides a transition from the entry song to an exit song.

In at least some embodiments, the transition metadata files are created by a DJ service that provides transitions from specific entry songs to specific exit songs. The DJ service creates transition metadata files by capturing adjustments made by a user to an entry song and/or an exit song to transition from the entry song to the exit song.

### BRIEF DESCRIPTION OF THE DRAWINGS

The same numbers are used throughout the drawings to reference like features.

FIG. 1 illustrates an operating environment in accordance with one or more embodiments.

FIG. 2 is a flow diagram that describes steps in a method in accordance with one or more embodiments.

FIG. 3 is a flow diagram that describes steps in a method in accordance with one or more embodiments.

FIG. 4 illustrates an implementation example in accordance with one or more embodiments.

FIG. 5 is a block diagram of an example system that can be utilized to implement one or more embodiments.

### DETAILED DESCRIPTION

Overview

Various embodiments provide a transition service that provisions transition metadata files for use by client devices. The transition metadata files are configured to provide song-specific transitions between songs. In at least some embodiments, the transition service receives a request for a transition metadata file associated with at least an entry song from a client device. The transition service then selects an associated transition metadata file and transmits the associated transition metadata file to the client device for execution. When executed during the playback of the entry song at the client device, the transition metadata file provides a transition from the entry song to an exit song.

In at least some embodiments, the transition metadata files are created by a DJ service that provides transitions from specific entry songs to specific exit songs. The DJ service creates transition metadata files by capturing adjustments made by a user to an entry song and/or an exit song to transition from the entry song to the exit song.

In the discussion that follows, a section entitled “Operating Environment” describes but one operating environment that can be utilized to practice the inventive principles described herein in accordance with one or more embodiments. Following this, a section entitled “DJ Service” describes an example DJ service in accordance with one or more embodiments. Next, a section entitled “Transition Service” describes an example transition service in accordance with one or more embodiments. Next, a section entitled “Example Method” describes an example method in accordance with one or more embodiments. Next, a section entitled “Implementation Example” is provided and describes an example transition metadata file that can be executed to transition between songs. Last, a section entitled “Example System” describes an example system that can be utilized to implement the described embodiments.

Operating Environment

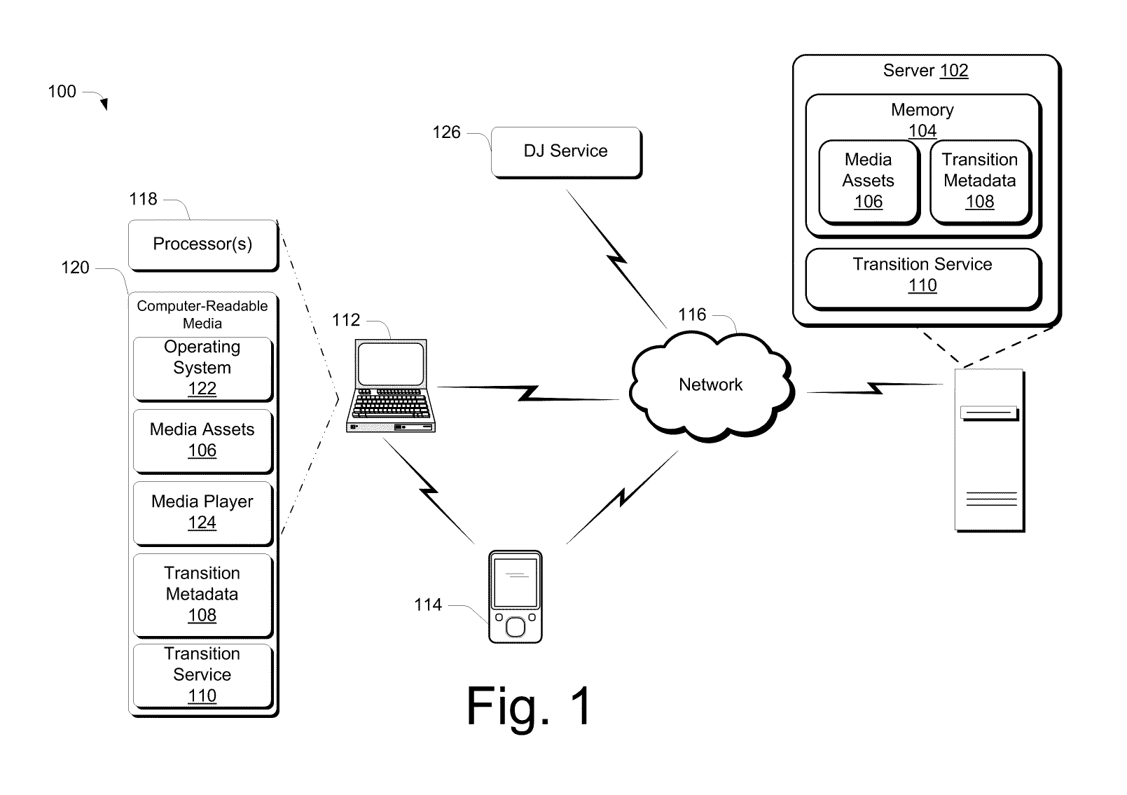

FIG. 1 illustrates an operating environment in accordance with one or more embodiments, generally at 100. Operating environment 100 includes a server 102 that includes a memory 104 to store or otherwise maintain various data and media assets, such as media assets 106 and transition metadata 108. In accordance with various embodiments, server 102 also includes a transition service 110 that can be implemented as computer-executable instructions and executed by processors to implement the various embodiments described herein. Server 102 is configured to communicate or otherwise provide media assets 106 and transition metadata 108, e.g. embodied in transition metadata files, to any number of various client devices, such as computing device 112 and portable media device 114, via a network 116, such as a local network or the Internet.

Devices 112 and 114 can be used to store and render media assets 106 (e.g., songs and videos) as well as transition metadata 108. Individual devices can typically include one or more processors 118, one or more computer-readable media 120, an operating system 122, one or more media assets 106, and a media player 124 that reside on the computer-readable media and which can executed by the processor(s) to render the media asset(s). The computer-readable media can include, by way of example and not limitation, all forms of volatile and non-volatile memory and/or storage media that are typically associated with a computing device. Such media can include ROM, RAM, flash memory, hard disk, removable media and the like.

Media assets 106 and transition metadata 108 can be downloaded and/or streamed from server 102 via network 116 to devices 112 and 114. Devices 112 and 114 can also receive media assets and transition metadata from alternate other sources (e.g., downloaded from a CD or downloaded from a third party service). In at least some embodiments, transition service 110 can be implemented, at least in part, on devices 112 and/or 114.

Computing device 112 can be embodied as any suitable computing device such as, by way of example and not limitation, a desktop computer, a portable computer, a handheld computer such as a personal digital assistant, a cell phone, and the like. Portable media device 114 can be embodied as any suitable portable media device that is configured to render media assets. In at least some embodiments, portable media device 114 can be wired and/or wirelessly connected to computing device 112 to receive media assets 106 and/or transition metadata 108 from computing device 112. Portable media device 114 can also be wired or wirelessly connected to network 116 to receive media assets 106 and/or transition metadata 108 directly from server 102.

In at least some embodiments, operating environment 100 includes a DJ service 126 that is configured to create transition metadata files and provide the metadata files to server 102 and/or devices 112 and 114 via network 116. DJ service 126 can be configured to execute at server 102, at devices 112 or 114, or at any other device or server connectable to network 116.

Having discussed the general notion of an example operating environment in which various embodiments can operate, consider now a more detailed discussion of a DJ service in accordance with one or more embodiments.

DJ Service

Both professional and amateur DJs use a variety of specialized tools to mix songs together. Using these specialized tools, a DJ can implement a variety of adjustments or tweaks to modify the characteristics or settings of songs in order to seamlessly transition from a currently-playing song to a next song. These adjustments may include, without limitation, crossfading, beatmatching, cueing, adjusting tempo, adjusting tone, and equalizing to name just a few.

In accordance with various embodiments, a DJ service can be implemented to capture adjustments made by a user to an entry song and/or an exit song to transition from the entry song to the exit song. As defined herein, the term “entry song” refers to a song that can be currently playing and the term “exit song” refers to a next song to be played. After capturing the adjustments, the DJ service creates a transition metadata file that includes information describing the adjustments made by the user associated with the entry song and/or the exit song. When executed by a media player during playback of the entry song, the transition metadata file can be used by the media player to provide a transition from the entry song to the exit song. It is to be appreciated that a variety of different users can use the DJ service, from professional DJs to amateur users that have access to DJ tools and the DJ service.

Consider for example, that world famous DJ Aqua is playing an entry song at a club in Seattle and would like to play an exit song next. Rather than simply waiting until the entry song ends to begin playing the exit song, DJ Aqua can mix or blend the exit song into the entry song by adjusting or tweaking the characteristics or settings of the entry song and/or the exit song. For example, DJ Aqua may tweak the settings of the entry song by slowing down or deemphasizing the beat or by lowering the playback volume. DJ Aqua may also queue up the exit song to begin playing at a specific time. For instance, the exit song can be queued up to start playing one minute into the exit song. DJ Aqua may then begin crossfading or integrating the exit song into the entry song by playing the exit song while the entry song is still playing until the entry song is finished and only the exit song is playing.

This process can continue for each subsequent song that is played. In this way, DJ Aqua uses a variety of specialized tools to reduce or eliminate gaps or silence that can occur between songs, and replace the gaps with a seamless transition that integrates or blends two songs together. If a recording was made of the songs played by DJ Aqua in the club in Seattle, that the recording would be a single long audio file.

Therefore, in accordance with various embodiments, the DJ service can be implemented to create transition metadata files by capturing the adjustments or tweaks made by a user to an entry song and, in at least some instances, an exit song to transition from the entry song to the exit song. In other words, rather than recording the actual songs, the DJ service captures the adjustments or tweaks that are applied by a DJ to move from one song to the next. The adjustments are then stored in a transition metadata file that is executable, during playback of the entry song, to provide a transition between the entry song and an exit song as if an actual DJ was transitioning between songs.

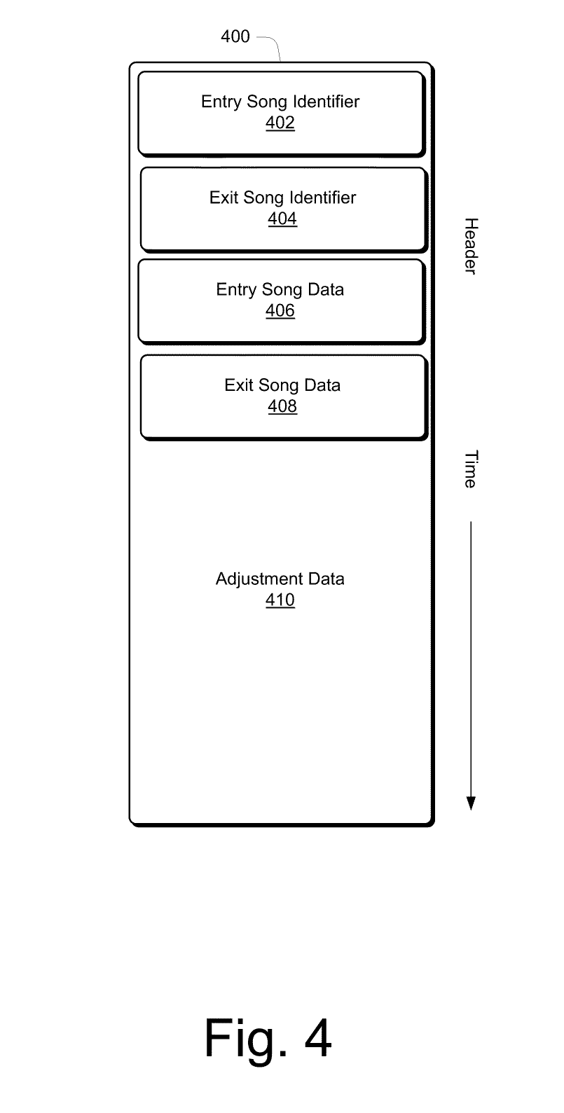

In accordance with various embodiments, the DJ service creates a transition metadata file that includes identifiers of the entry song and/or the exit song. Including entry song and exit song identifiers in the transition metadata file indicates that the transition metadata file is specifically configured to transition from the identified entry song to the identified exit song. In at least one embodiment, the entry song and exit song identifiers comprise a song name of the entry song and the exit song. It is to be appreciated, however, that songs can be renamed by a user, or downloaded with different names. For instance, a user could download “Song 1” in MP3 form from a website, and rename Song 1 as “Song 1000”. Similarly, a user can change other data associated with a song, such as an album name, an artist name, or a genre of the song. For example, a user could change the genre of a song from Rock to Alternative. Therefore, in at least one embodiment, the entry song and exit song identifiers in the transition metadata file can comprise other data, such as waveform information regarding the waveform of the entry song and the exit song. Thus, even if a user changes the name of a song, the song can be identified by its waveform which will remain the same. It is to be appreciated, however, that songs that are the same may have slightly different waveform information due to lossy compression algorithms used to decompress the songs on different devices. Therefore, in at least some embodiments, songs that are the same can be identified as the same song even if the waveforms of the songs have slight or unimportant differences due to lossy decompression. An example transition metadata file is illustrated in FIG. 4, and described in more detail below.

After creating the transition metadata file, the DJ service can transmit the transition metadata file to a transition service, such as transition service 110 at server 102, for subsequent transmission to a device. In accordance with some embodiments, the DJ service can also download or stream transition metadata files directly to a transition service executing at device(s) 112 or 114 for use by the devices' media players.

Having discussed the general notion of a DJ service in accordance with various embodiments, consider now a more detailed discussion of a transition service in accordance with one or more embodiments.

Transition Service

In various embodiments, a transition service provisions transition metadata files for use by client devices. As noted above, in at least some embodiments, the transition metadata files can be received from a suitably-configured DJ service. The transition metadata files are configured to provide song-specific transitions between songs when the songs are played. The transition service, such as transition service 110 illustrated in FIG. 1, can be implemented, at least in part, at server 102 and/or at devices 112 and 114. In at least some embodiments, the transition service is implemented at server 102 and provides transition metadata 108, via network 116, to various devices in the system that are equipped with a media player that is configured to receive and process transition metadata files to effect transitions between songs.

In one or more embodiments, the transition service stores the transition metadata files so that the files are searchable. As described above, transition metadata files include identifiers of an entry song and/or an exit song. Therefore, the transition service can store the transition metadata files so that the files are searchable by an associated entry song identifier and/or an associated exit song identifier. As described above, the entry song and exit song identifiers may include both song name identifiers and/or other identifying information such as waveform identifiers.

In one or more embodiments, the transition service can receive requests for transitions for entry songs from various client devices. Requests for transitions can be initiated by media players executing on client devices, such as media player 124 executing on device(s) 112 and/or 114. In one or more embodiments, a request for a transition can be initiated by a media player before songs are played and/or while songs are being played. To make a request, the media player typically includes one or more song identifiers with the request so that the transition service can search for an appropriate transition metadata file.

Responsive to receiving a request for a transition associated with an entry song, the transition service can search for and select an associated transition metadata file that includes the identifier of the entry song. In some instances, the transition service's search can generate a listing of multiple transition metadata files. In this case, the transition service can make a file selection from the listing, based on one or more factors that are described below in more detail.

In one or more embodiments, transition metadata files can include, for a particular associated entry song, an exit song identifier that can serve as the next song played after the entry song is played. In these instances, if a media player generates a request that does not include an exit song identifier, the transition service, by virtue of returning the transition metadata file including the exit song identifier, can cause media players to select the exit song as the next song, and use the transition metadata file to transition between songs.

In at least some embodiments, a media player can generate a request that includes both an entry song and an exit song identifier. In these instances, the transition service can select an associated transition metadata file that includes both the identifier of the entry song and of the exit song. In order to select an associated transition metadata file, the transition service can search for transition metadata files that include both the identifier of the entry song and the exit song specified in the request, and generate a listing of multiple transition metadata files found in the search. Then, the transition service can make a file selection from the listing, based on one or more factors described below.

Consider for example, a media player that is playing an entry song in a playlist where the next song in the playlist is a specific exit song. The media player can generate a transition request, either before the song or associated playlist is played, or while songs from the associated playlist are played, that identifies both the entry song and the exit song. The transition service can then search for and select a transition metadata file that can be used to transition from the specific entry song to the specific exit song identified in the request. It is to be appreciated, therefore, that when both the entry song and the exit songs are identified in the request, that the transition service can search for and select a transition metadata file that is configured to transition from the specific entry song to the specific exit song identified in the request.

After selecting a transition metadata file, the transition service can provide the transition metadata file to a media player on a client device, such as computing device 112 or portable media device 114. The media player can then execute the transition metadata file to provide a transition between songs.

When executed, the transition metadata file can be used by the media player to apply adjustments identified in the transition metadata file to the entry song and/or the exit song identified in the file. For example, the transition metadata file can apply the adjustments and tweaks to the characteristics and settings of an entry song and an exit song in the same manner as if a DJ were transitioning between the entry song and the exit song.

Other Factors Considered when Selecting a Transition Metadata File

In at least some embodiments, the transition service can consider a variety of factors, other than just the entry song and exit song identifiers, when selecting a transition metadata file. In at least one embodiment, the transition service can select a transition metadata file, based at least in part, on a user rating associated with the transition metadata file. The transition service can receive user ratings of transition metadata files from various users and compile the user ratings to create an associated user rating for each file. For example, each time a transition metadata file is played by a user, the user can be presented with an option to assign a user rating to the transition metadata file. This user rating can be received by the transition service and compiled with other user ratings received for the transition metadata file to provide a collective user rating. Accordingly, in at least some embodiments, a request may include an indication that a transition having a particular user rating is requested. The transition service can then select an associated transition metadata file that has the desired user rating.

In at least some embodiments, the transition service can select a transition metadata file based on a genre of music (e.g., hip hop, electronic, pop, rock, or country). For instance, a request can be received for a transition that identifies both an entry song as well as a specific genre of music. The transition service can then select a transition metadata file that can be used to transition from the entry song to an exit song that is of the specific genre indicated in the request. In at least some embodiments, when a request is received that only identifies an entry song, the transition service can cause selection of an exit song that is of the same genre as the entry song in the request in a manner similar to that described above.

In at least some embodiments, the transition service can select a transition metadata file based on a requested DJ. For instance, a request can be received for a transition metadata file associated with a song or songs that also includes a request for a transition by a specific DJ. The transition service can then select a transition metadata file that was created by the specific DJ. Similarly, in at least some embodiments, a user can specify favorite DJs, and the transition service will select transition metadata files associated with the user's favorite DJs whenever possible.

Unsatisfied Transition Requests

In at least some embodiments, the transition service may be unable to select a transition metadata file that satisfies the requirements of a transition request. For example, a request could be received to transition between an entry song and an exit song. However, the transition service may determine that no transition metadata file exists for the specific entry song and the specific exit song. The transition service can then transmit a notification to the requestor that no transition metadata file that satisfies the requirements of the request is available.

Alternately or additionally, when the transition service is unable to select a transition metadata file that satisfies the requirements of a transition request, the transition service may provide a requestor with an option to provide a transition metadata file that satisfies the requirements of a request. That is, if the requestor happens to have access to a transition metadata file that satisfies the requirements of the request, the requestor can then upload the transition metadata file to the transition service. Furthermore, if the requestor has access to the DJ service, the requestor could create a transition metadata file that satisfies the requirements of the request and then upload it to the transition service.

Alternately or additionally, when the transition service is unable to select a transition metadata file that satisfies the requirements of a transition request, the transition service may create a notification that a specific transition metadata file is desired by one or more users. In this way, users of the DJ service and/or the transition service can create and upload transition metadata files that are in high demand. Similarly, users of the DJ service can ask the transition service to suggest song transitions that are in high demand for a subset of available songs. For example, a user of the DJ service that has access to 50 songs can ask the transition service to suggest transitions between songs that are in high demand for the subset of 50 songs available to the user. The transition service can then suggest song transitions that are in high demand for the subset of songs available to the user.

Alternately or additionally, when the transition service is unable to select a transition metadata file that satisfies the requirements of a transition request, the transition service can transmit a generic transition metadata file that is not associated with either a specific entry song or a specific exit song. For instance, the transition service may transmit a generic transition metadata file that simply crossfades between an entry song and an exit song to provide a generic transition between the entry song and the exit song.

Alternately or additionally, when the transition service is unable to select a transition metadata file that satisfies the requirements of a transition request, the transition service can transmit a similar transition metadata file that is configured to transition between songs that have similar characteristics to the songs identified in a request. Consider for example, that the transition service is unable to find a transition metadata file to transition from a first song to a second song. In this instance, songs that have similar characteristics to the first song and songs that have similar characteristics to the second song can be determined by the transition service and/or another service. The transition service can then search for transition metadata files that are configured to transition between one of the songs that have similar characteristics to the first song and one of the songs that have similar characteristics to the second song. If, for example, it is determined that a third song has similar characteristics to the first song and a fourth song has similar characteristics to the second song, the transition service can search for a transition metadata file configured to transition between the third song and the fourth song. If the transition service finds a transition metadata file that transitions between songs that have similar characteristics to the songs identified in a request, this transition metadata file can be transmitted to the requestor and applied to the appropriate songs.

Transitions for Multiple Songs

In various embodiments, the transition service can provide multiple transition metadata files for multiple songs in a playlist. For example, the transition service can receive a request that includes an identifier of multiple songs in a playlist, as well as an identifier of the specific order of the multiple songs in the playlist. The transition service can then search for, select, and provide multiple transition metadata files for each transition between songs in the playlist in the specified order. For example, the transition service can search for and select a transition metadata file with an entry song identifier and an exit song identifier for the first and second songs in the playlist, the second and third songs in the playlist and so on.

In at least some embodiments, the transition service can reorder songs in a playlist in order to provide a desired number of transitions between songs in the reordered playlist. For example, in some cases transition metadata files may not exist for each specific transition between songs in a playlist. For instance, there may not be a transition metadata file to transition from the first song in the playlist to the second song. However, there may be a transition metadata file to transition from the second song to the first song. In this case, the transition service can reorder the playlist so that a transition metadata file can be provided for transitions between as many songs as possible. In other words, the transition service selects a desired order of songs in the playlist to increase the number of song-specific transitions that can be used.

Alternately or additionally, the transition service can create a modified playlist by adding songs to the playlist that were not identified in the playlist request. The transition service can search for and select transition metadata files that are associated with at least one song in the playlist as well as an additional song that is not in the playlist. The transition service can then reorder and modify the playlist to provide a playlist that includes both songs in the playlist and additional songs with transitions between as many songs as possible in the reordered and modified playlist.

Smart DJ Service

In at least some embodiments, the transition service can be implemented in combination with a “Smart DJ Service” to provide transition metadata files between songs in a playlist created by the Smart DJ Service. The Smart DJ Service can receive a Smart DJ playlist request that includes an identifier of a requested song. The Smart DJ service can then create a playlist of songs that includes the requested song, as well as other songs that are similar or related to the requested song (e.g., songs of the same genre as the requested song, songs by the same artist as the requested song, and/or songs that are similar to the requested song).

The transition service can also provide transition metadata files for transitions between songs in a playlist created by the Smart DJ Service. The transition service can search through a listing of similar songs determined by the Smart DJ Service, and select the next song in the Smart DJ playlist based on the availability of transition metadata files. Thus, in at least some embodiments, the order of the playlist created by the Smart DJ Service may be based, at least in part, on the availability of transition metadata files between songs in the playlist.

Consider for example, that a Smart DJ playlist request is received for a first song, and that the Smart DJ Service determines that similar songs include a second song, a third song, a fourth song, and a fifth song. The transition service can search through the transition metadata files to determine if transition metadata files exist for any two of the songs. If the transition service finds a transition metadata file to transition from the first song to the fourth song, and from the fourth song to the second song, the transition service may reorder the Smart DJ playlist to play the first song, followed by the fourth song, followed by the second song, and so on, and provide transition metadata files to transition between the songs in the reordered Smart DJ playlist.

Having considered an example transition service, consider now an example method that the DJ service and the transition service can implement in accordance with one or more embodiments.

Example Method

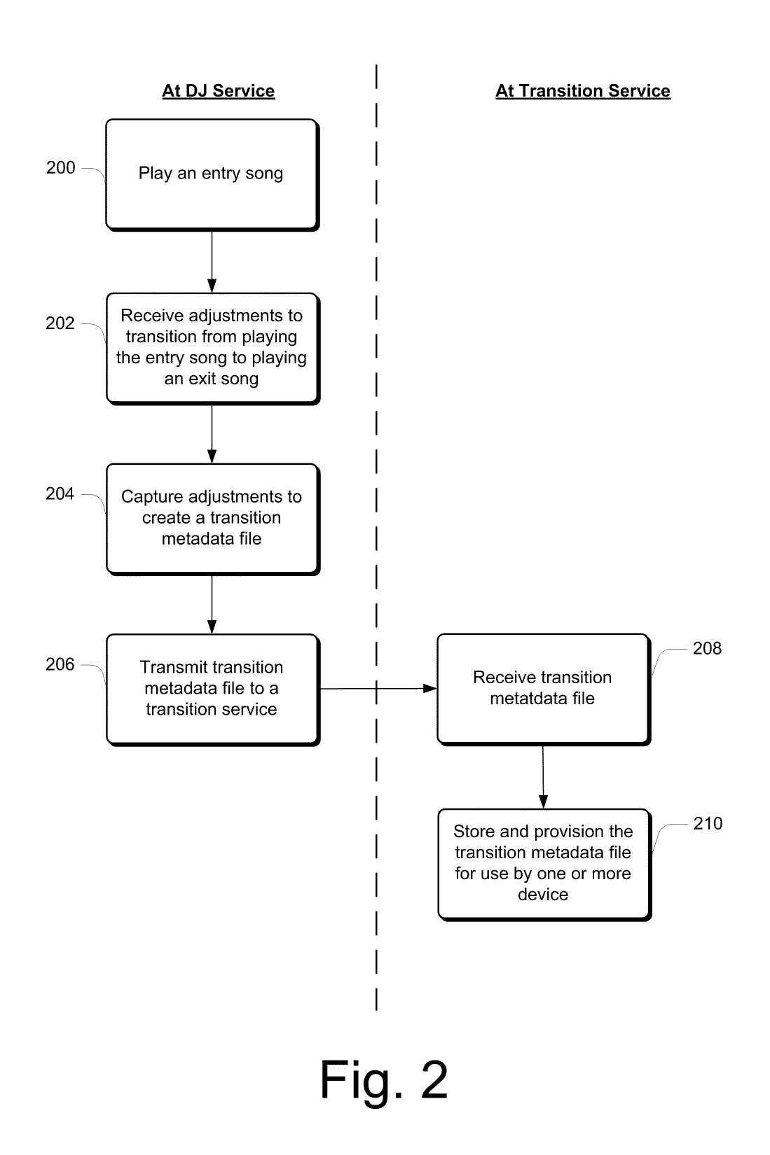

FIG. 2 is a flow diagram that describes steps in a method in accordance with one or more embodiments. The method can be implemented in connection with any suitable hardware, software, firmware, or combination thereof. In at least some embodiments, aspects of the method can be performed by a DJ service, such as DJ service 126, and by a transition service, such as transition service 110, executing on a client device or on a server, such as the client devices and server illustrated in FIG. 1.

Step 200 plays an entry song. Step 202 receives adjustments to transition from playing the entry song to playing an exit song. For example, a DJ can implement a variety of different adjustments or tweaks to modify the characteristics or settings of songs in order to transition from an entry song to an exit song. Such adjustments may include without limitation crossfading, beatmatching, cueing, adjusting tempo, adjusting tone, and equalizing.

Step 204 captures the adjustments to create a transition metadata file. In accordance with various embodiments, the transition metadata file can include identifiers of the entry song and/or the exit song, as well as timing information associated with when the adjustments were made, magnitudes of the adjustments and the like. In at least some embodiments, the transition metadata file can also include entry song data and exit song data, such as a start time and a stop time of the entry song and the exit song.

Step 206 transmits the transition metadata file to a transition service. For example, after creating a transition metadata file, the DJ service can transmit the transition metadata file to a server 102, to be stored with transition metadata 108, or directly to a device 112 or 114.

Step 208 receives, from the DJ service, the transition metadata file. Step 210 stores the transition metadata file and provisions the transition metadata file for use by one or more device as described above.

Having discussed an example method that the DJ service and the transition service can implement, consider now an example method that a media player and the transition service can implement in accordance with one or more embodiments.

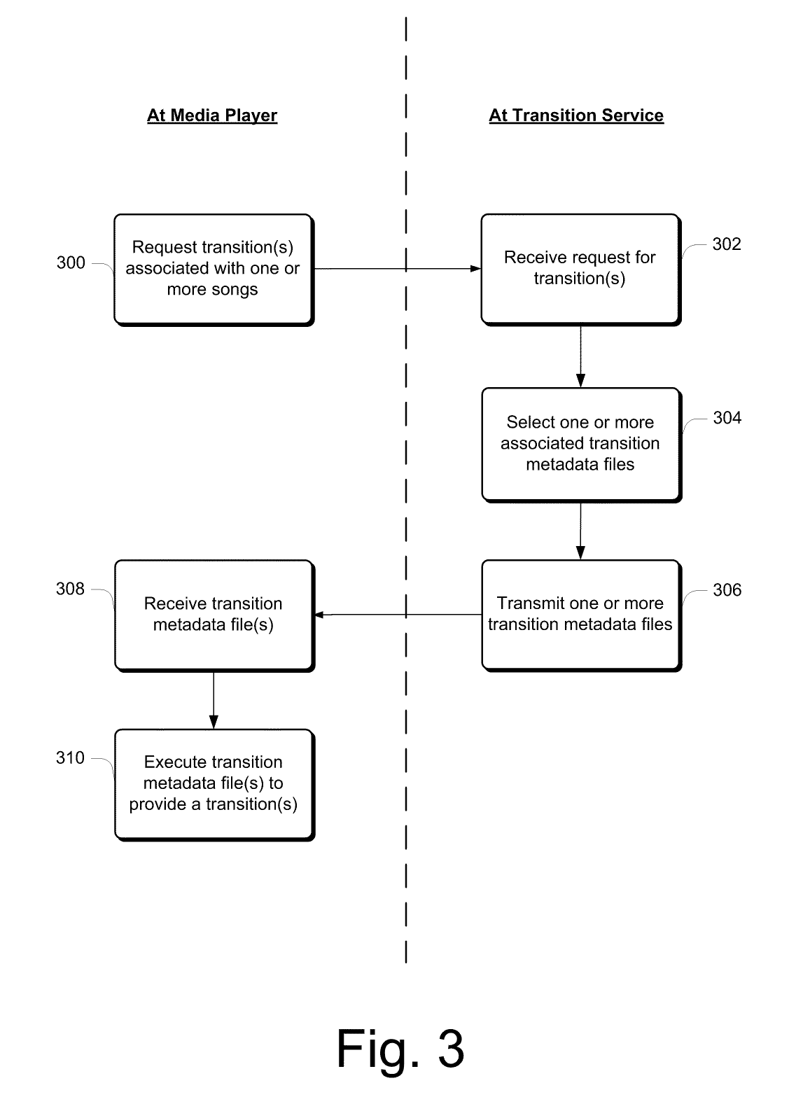

FIG. 3 is a flow diagram that describes steps in a method in accordance with one or more embodiments. The method can be implemented in connection with any suitable hardware, software, firmware, or combination thereof. In at least some embodiments, aspects of the method can be performed by a media player, such as media player 124, and by a transition service, such as transition service 110, executing on a client device or on a server, such as the client devices and server illustrated in FIG. 1.

Step 300 requests transition(s) associated with one or more songs. For example, the request may specify an entry song, an entry song and an exit song, and/or multiple entry and exit songs. The request can be generated at any suitable time. For example, in advance of playing songs on a particular playlist, an application, such as a media player, may generate a request for one or more transitions. Alternately or additionally, transition requests can be generated during song or playlist play.

Step 302 receives, at the transition service, the transmitted request for the transition(s). Step 304 selects one or more associated transition metadata files associated with the specified song(s). Examples of how this can be done are provided above. Step 306 transmits one or more transition metadata files to a device on which the media player resides.

Step 308 receives the transition metadata file(s) from the transition service. Step 310 executes the transition metadata file(s) to provide a transition(s) between songs.

Having discussed an example method, consider now an implementation example.

Implementation Example

FIG. 4 illustrates an example transition metadata file 400 in accordance with one or more embodiments. Transition metadata file 400 includes a header that indicates an entry song identifier 402, an exit song identifier 404, entry song data 406, exit song data 408, as well as timing information such as time specific adjustment data 410.

In some embodiments, entry song identifier 402 and exit song identifier 404 comprise a song name of the entry song and the exit song, respectively. In yet other embodiments, entry song identifier 402 and exit song identifier 404 can comprise other information such as, by way of example and not limitation, waveform information of the entry song and the exit song, respectively.

Entry song data 406 and exit song data 408 include information such as a start time and a stop time for both the entry song and the exit song. For instance, the start time of the entry song indicates the time in the entry song at which the transition is to start to be applied to the entry song. The stop time of the entry song indicates the time in the entry song at which the entry song is to stop playing (and only the exit song will play). Similarly, the start time in the exit song indicates the time in the exit song at which the exit song is to begin to play and the stop time of the exit song indicates the time in the exit song when the adjustments to the exit song are to stop. It is to be appreciated that if the entry song is still playing when the exit song stops playing, that the entry song will also stop playing at this time.

Adjustment data 410 includes information that is used to adjust the characteristics and settings of the entry song and the exit song to provide a transition from the entry song to the exit song. The adjustment data includes not only specific adjustments that are to be made to the entry song and/or the exit song, but timing information associated with those adjustments as well. Such adjustments may include without limitation crossfading, beatmatching, cueing, adjusting tempo, adjusting tone, and equalizing, to name just a few.

It is to be appreciated that a variety of additional information can be included in the transition metadata file. For instance, in at least some embodiments the transition metadata file can include a DJ identifier that identifies the name of the DJ that created the transition metadata file.

Having discussed an implementation example, consider now a discussion of an example system that can be used to implement one or more embodiments.

Example System

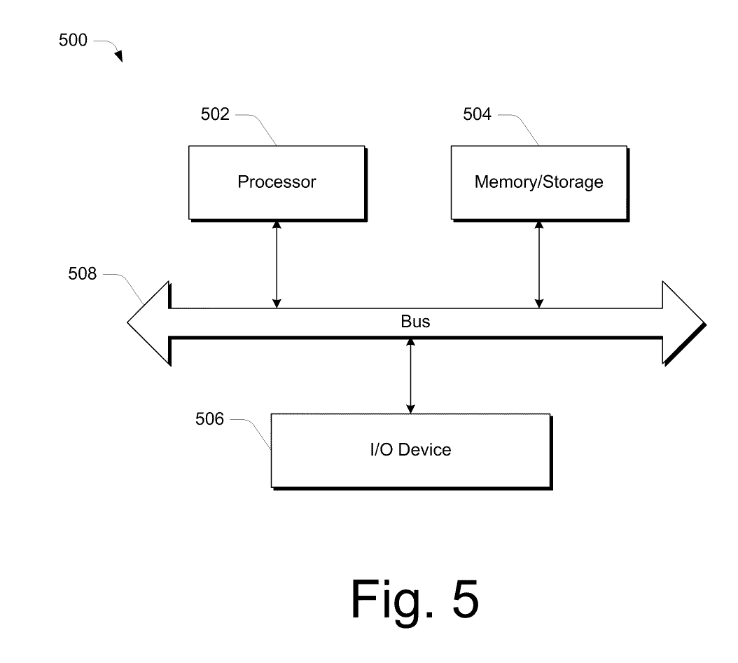

FIG. 5 illustrates an example computing device 500 that can implement the various embodiments described above. Computing device 500 can be, for example, various computing devices or servers, such as those illustrated in FIG. 1 or any other suitable computing device.

Computing device 500 includes one or more processors or processing units 502, one or more memory and/or storage components 504, one or more input/output (I/O) devices 506, and a bus 508 that allows the various components and devices to communicate with one another. Bus 508 represents one or more of any of several types of bus structures, including a memory bus or memory controller, a peripheral bus, an accelerated graphics port, and a processor or local bus using any of a variety of bus architectures. Bus 508 can include wired and/or wireless buses.

Memory/storage component 504 represents one or more computer storage media. Component 504 can include volatile media (such as random access memory (RAM)) and/or nonvolatile media (such as read only memory (ROM), Flash memory, optical disks, magnetic disks, and so forth). Component 504 can include fixed media (e.g., RAM, ROM, a fixed hard drive, etc.) as well as removable media (e.g., a Flash memory drive, a removable hard drive, an optical disk, and so forth).

One or more input/output devices 506 allow a user to enter commands and information to computing device 500, and also allow information to be presented to the user and/or other components or devices. Examples of input devices include a keyboard, a cursor control device (e.g., a mouse), a microphone, a scanner, and so forth. Examples of output devices include a display device (e.g., a monitor or projector), speakers, a printer, a network card, and so forth. In at least some embodiments, input/output device 506 comprises a midi controller.

Various techniques may be described herein in the general context of software or program modules. Generally, software includes routines, programs, objects, components, data structures, and so forth that perform particular tasks or implement particular abstract data types. An implementation of these modules and techniques may be stored on or transmitted across some form of computer readable media. Computer readable media can be any available medium or media that can be accessed by a computing device. By way of example, and not limitation, computer readable media may comprise “computer storage media”.

“Computer storage media” include volatile and non-volatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

### CONCLUSION

Various embodiments provide a transition service that provisions transition metadata files for use by client devices. The transition metadata files are configured to provide song-specific transitions between songs. In at least some embodiments, the transition service receives a request for a transition metadata file associated with at least an entry song from a client device. The transition service then selects an associated transition metadata file and transmits the associated transition metadata file to the client device for execution. When executed during the playback of the entry song at the client device, the transition metadata file provides a transition from the entry song to an exit song.

In at least some embodiments, the transition metadata files are created by a DJ service that provides transitions from specific entry songs to specific exit songs. The DJ service creates transition metadata files by capturing adjustments made by a user to an entry song and/or an exit song to transition from the entry song to the exit song.

Although the subject matter has been described in language specific to structural features and/or methodological steps, it is to be understood that the subject matter defined in the appended claims is not necessarily limited to the specific features or steps described. Rather, the specific features and steps are disclosed as example forms of implementing the claimed subject matter

What is claimed is:

1. One or more computer-readable storage media embodying computer executable instructions, which when executed by a computing device, perform a method, comprising:
receiving, from a client device, a request for a transition associated with at least an entry song;
selecting an associated transition metadata file; and
transmitting the associated transition metadata file to the client device.

2. One or more computer-readable storage media as recited in claim 1, wherein the transition metadata file is executable to provide a transition from the entry song to an exit song.

3. One or more computer-readable storage media as recited in claim 1, wherein selecting an associated transition metadata file comprises:
searching for transition metadata files associated with the entry song to generate a listing of transition metadata files associated with the entry song; and
selecting the associated transition metadata file from the listing based at least in part on a user rating of the associated transition metadata file.

4. One or more computer-readable storage media as recited in claim 1, wherein the request specifies an exit song.

5. One or more computer-readable storage media as recited in claim 4, wherein selecting an associated transition metadata file comprises:
searching for transition metadata files associated with both the entry song and the exit song to generate a listing of transition metadata files associated with the entry song and the exit song; and
selecting the associated transition metadata file from the listing based at least in part on a user rating of the associated transition metadata file.

6. One or more computer-readable storage media as recited in claim 4, wherein transmitting comprises transmitting a generic transition metadata file or a similar transition metadata file responsive to determining that a transition metadata file that is associated with the entry song and the exit song is not available.

7. One or more computer-readable storage media as recited in claim 1, further comprising:
receiving a user rating of the associated transition metadata file from the client device; and
compiling the user rating with one or more additional user ratings received for the associated transition metadata file from one or more additional client devices.

8. One or more computer-readable storage media as recited in claim 1, further comprising receiving the associated transition metadata file from a DJ service prior to receiving the request for a transition.

9. One or more computer-readable storage media as recited in claim 1, wherein the request is received at a server, and wherein the client device is located remote from the server.

10. A computer-implemented method comprising:
requesting, from a transition service, a transition associated with at least an entry song;
receiving, from the transition service, an associated transition metadata file associated with the entry song and an exit song; and
executing the transition metadata file to provide a transition from the entry song to the exit song.

11. The computer-implemented method as recited in claim 10, wherein executing the transition metadata file comprises applying adjustments identified in the transition metadata file to the entry song and the exit song to provide the transition.

12. The computer-implemented method as recited claim 10, wherein requesting a transition includes requesting a transition associated with a particular DJ.

13. The computer-implemented method as recited in claim 10, further comprising transmitting a rating of the transition metadata file to the transition service.

14. The computer-implemented method as recited in claim 10, wherein requesting a transition comprises requesting a transition metadata file associated with the exit song.

15. The computer-implemented method as recited in claim 14, wherein the associated transition metadata file includes an identifier of both the entry song and the exit song and is configured to provide a song-specific transition from the entry song to the exit song.

16. A computer-implemented method comprising:
receiving, at a server, transition metadata files that are configured to enable transitions between songs;
storing the transition metadata files; and
provisioning the transition metadata files for use by one or more client devices.

17. The computer-implemented method as recited in claim 16, wherein at least some of the transition metadata files include an identifier of an entry song and an identifier of an exit song.

18. The computer-implemented method as recited in claim 17, wherein the transition metadata files include adjustment data configured to adjust characteristics and settings of the entry song and the exit song to provide a transition from the entry song to the exit song.

19. The computer-implemented method as recited in claim 16, wherein the receiving comprises receiving the transition metadata files from a DJ service.

20. The computer-implemented method as recited in claim 16, wherein storing the transition metadata files comprises storing the transition metadata files so that the transition metadata files are searchable by an associated entry song identifier or by an associated exit song identifier.
